(19) United States
(12) Patent Application Publication
(10) Pub. No.: US 2007/0178766 A1
(43) Pub. Date: Aug. 2, 2007

(54) Passive impedance equalization of high speed serial links

(75) Inventors: Gaurab Banerjee, Portland, OR (US); Stephen R. Mooney, Beaverton, OR (US)

Correspondence Address: Ryder IP Law;C/O PortfolioIP, P.O. Box 52050, Minneapolis, MN, 55402, US

(73) Assignee: Intel Corporation

(21) Appl. No.: 11/343,780

(22) Filed: Jan. 31, 2006

(51) Int. Cl. H01R 33/00

(52) U.S. Cl. 439/638

(57) ABSTRACT

In some embodiments a passive impedance equalization network for high speed serial links is described. The impedance equalization network includes at least one stepped impedance transformer near points of impedance discontinuities. The impedance discontinuities may be at an interface connection between two circuit boards. The impedance discontinuities on a circuit board may be at a die-package interface and/or a package-board interface. The stepped impedance transformer may be formed in a package trace, a board trace or both. Forming the stepped impedance transformers in the traces requires no modification to existing package/board design methodology or technology. The stepped impedance transformers can provide impedance matching over a range of frequencies. To account for modeling errors in the design of the stepped impedance transformers integrated circuits transmitting data over the serial link may include active circuitry to select an output/input impedance for transmitters/receivers. Other embodiments are otherwise disclosed herein.

### BACKGROUND

Serial links are the paths between devices that are used to transmit data therebetween. The devices may include printed circuit boards, integrated circuits, other active devices, passive devices, or some combination thereof. The serial links may be used to connect circuit boards, integrated circuits mounted on a circuit board, components (active or passive) mounted on a circuit board, or some combination thereof. The serial links may include connectors to physically connect one device to another and traces to provide routing from one device to another. For example, circuit boards may be connected together using connectors, where one board may include male components (e.g., pins) and another board may include female components (e.g., receptacle).

If the devices are mounted on a circuit board the serial link may include metallization on the printed circuit board that connects the two devices together. The serial link may also include the connection of the components to the metallization on the circuit board. These connections may include solder balls, pads, vias or pins. If the devices are integrated circuits (ICs) that include die (silicon) and a package, the serial link may also include the connections between the die and the package and a path within the package from the die to the board. The die may be a flip-chip having its contacts on the bottom face and be surface mounted on the package. The contacts on the bottom face of the die may be solder (e.g., Lead/Tin (Pb/Sn)) bumps that have been evaporatively deposited or plated onto the die face (e.g., Controlled Collapse Chip Connection (C4) bumps and may be reflow soldered onto the package. In other embodiments, the die may use wire-bond technology or Tape Automated Bonding (TAB) to connect the die to the package substrate. The path between the package may include vias and traces.

The serial links may have discontinuities that may affect the performance thereof. The discontinuities may be caused by the connections between devices. For example, discontinuities may exist in connectors used to connect circuit boards (e.g., daughter cards connected to a backplane or mother board in a server, interface cards connected to a backplane in a store-and-forward device (e.g., router)). The discontinuities may also be the result of the active components on the die or the connectivity between the die and the package and the package and the circuit board. For example, the discontinuities may be the result of capacitance of the balls, pads or pins used to connect the IC and the board, capacitance of the bumps or bonds used to connect the die to the package, capacitance from the active devices, drivers, receivers, and ESD protection circuits on the die, inductance of the traces on the board or within the package, and interconnect transitions such as those from plated through hole (PTH) vias.

The discontinuities may result in impedance mismatches between the transmitting device and the receiving device. The impedance mismatches may result in power reflections that reduce amount of power received by the receiver and thus limit data rates. The impedances may be complex impedances that vary with frequency. Accordingly, the impedance mismatches between transmitter and receiver may vary over a range of frequencies. Broadband systems operate over a wide range of frequencies so that the operation of these systems may be effected by these complex impedance mismatches. Data rates on high speed serial links (e.g., 8-inch desktop serial links, 20-inch server channels) may be limited by impedance discontinuities.

### BRIEF DESCRIPTION OF THE DRAWINGS

The features and advantages of the various embodiments will become apparent from the following detailed description in which:

FIGS. 1A-C illustrate an example connection of two integrated circuits on a circuit board and impedance mismatches existing therebetween, according to one embodiment;

FIG. 2 illustrates an example schematic of impedance matching networks being utilized in a connection between a transmitter and receiver, according to one embodiment;

FIG. 3 illustrates an example trace having a stepped impedance transformer formed therein, according to one embodiment;

FIG. 4 illustrates an example output impedance selecting circuit for a transmitter, according to one embodiment;

FIG. 5 illustrates an example input impedance selecting circuit for a receiver, according to one embodiment;

FIG. 6 illustrates an example schematic of passive impedance matching networks and active impedance selecting circuitry being utilized in high-speed serial links, according to one embodiment;

FIG. 7 illustrates several example connections between circuit boards, according to one embodiment; and

FIG. 8 illustrates an example schematic of impedance matching networks being utilized in a connection between circuit boards, according to one embodiment.

### DETAILED DESCRIPTION

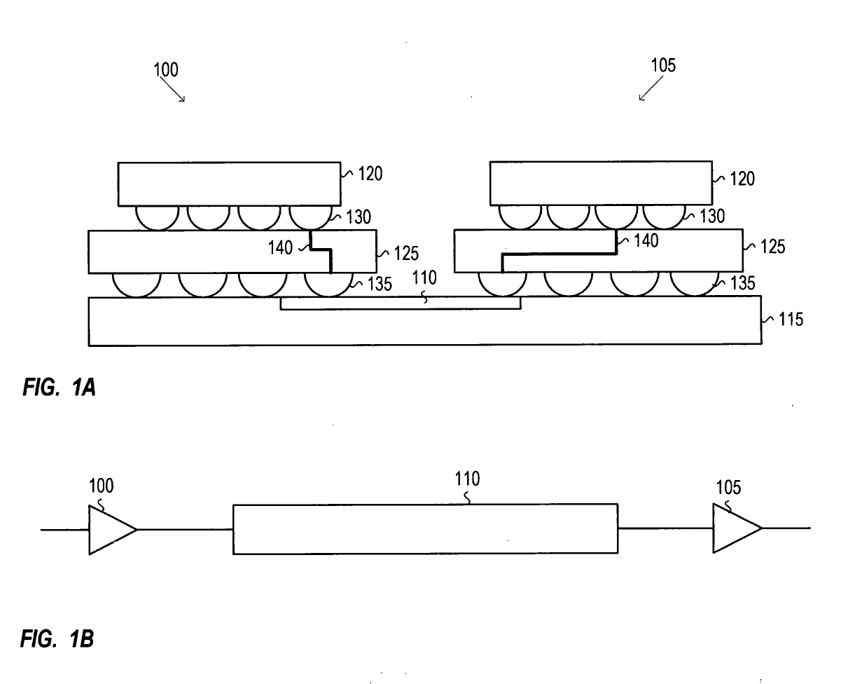

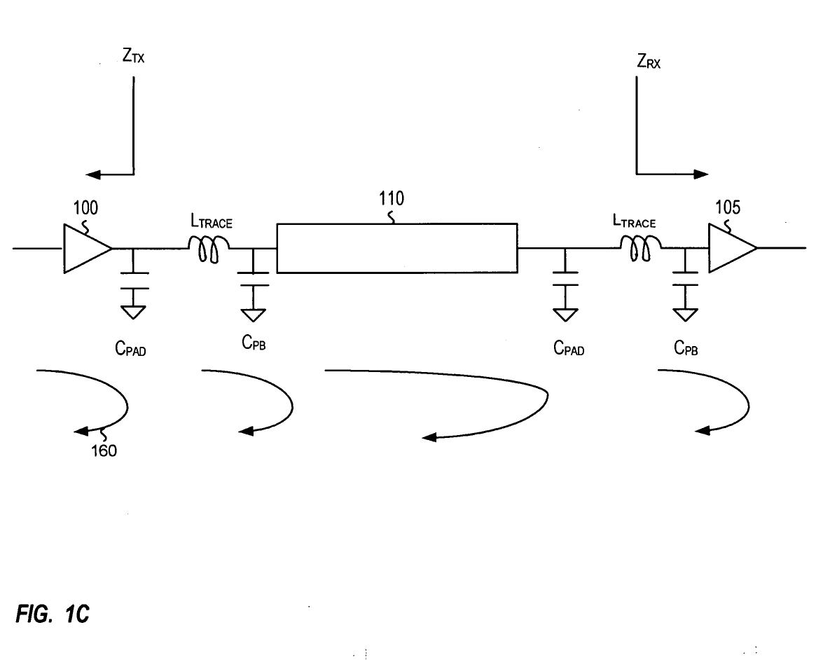

FIG. 1A illustrates an example connection of two integrated circuits on a printed circuit board. A transmitter 100 and a receiver 105 may be connected to one another using a conductive (metallic) trace 110 on the circuit board 115. The transmitter-receiver connection may be any combination of integrated circuits (ICs) communicating with one another for any reason (e.g., processor-processor, processor-memory, memory-processor). The trace 110 may be a microstrip, a stripeline, or a coupled transmission line. The transmitter 100 and receiver 105 may include a silicon die 120, such as a flip chip die, connected to a package 125 with bumps 130. The packages 125 may be connected to the board 115 using pin grid array (PGA) balls 135 or through a land Grid Array (LGA) socket The packages 125 may include vias and traces 140. The vias and traces 140 may connect appropriate bumps 130 and balls 135 so as to provide appropriate connectivity between the die 120 and the board 115. The trace 110 may then provide the appropriate connectivity between the transmitter 100 and the receiver 105.

FIG. 1B illustrates an example schematic of an ideal connection (trace 110) between the transmitter 100 and the receiver 105. The connection includes no discontinuities and the trace 110 has no losses (e.g., a lossless 50-ohm microstrip). However, in a real system, discontinuities will exist between the transmitter 100 and the receiver 105.

FIG. 1C illustrates an example schematic of connection (trace 110) between the transmitter 100 and the receiver 105 having discontinuities. The discontinuities may include bump capacitance, pad capacitance, on chip capacitance (active devices, drivers, receivers, and ESD protection circuits), interconnect transitions (such as connectors), and inductance of the traces. The discontinuities for both the transmitter 100 and the receiver 105 are illustrated as capacitance of the pad (C_{pad}), inductance of the trace (L_{trace}) and capacitance of the board (C_{PB}). The various transmitter discontinuities, together with the input/output impedance of the active devices and the characteristic impedance of the interconnect, make up the impedance of the transmitter (Z_{TX}). The various receiver discontinuities make up the impedance of the receiver (Z_{RX}). The mismatch in the impedances Z_{TX}, Z_{RX} may cause power reflections 160 at the different interfaces. That is, data being transmitted from the transmitter to the receiver may be reflected back toward the transmitter or may be lost. The trace may be a lossy 50-ohm microstrip.

For serially transmitted data the goal is to minimize power reflections and maximize power transmission over a specified range of frequencies. To increase the power transmission and decrease power reflections impedance matching networks may be utilized at one or more known locations of discontinuities to adjust for the complex impedances over a variety of frequencies. In addition to providing a maximum power transfer, the matching networks should also provide a linear phase response (or equivalently, a constant group-delay) to minimize inter-symbol-interference (ISI).

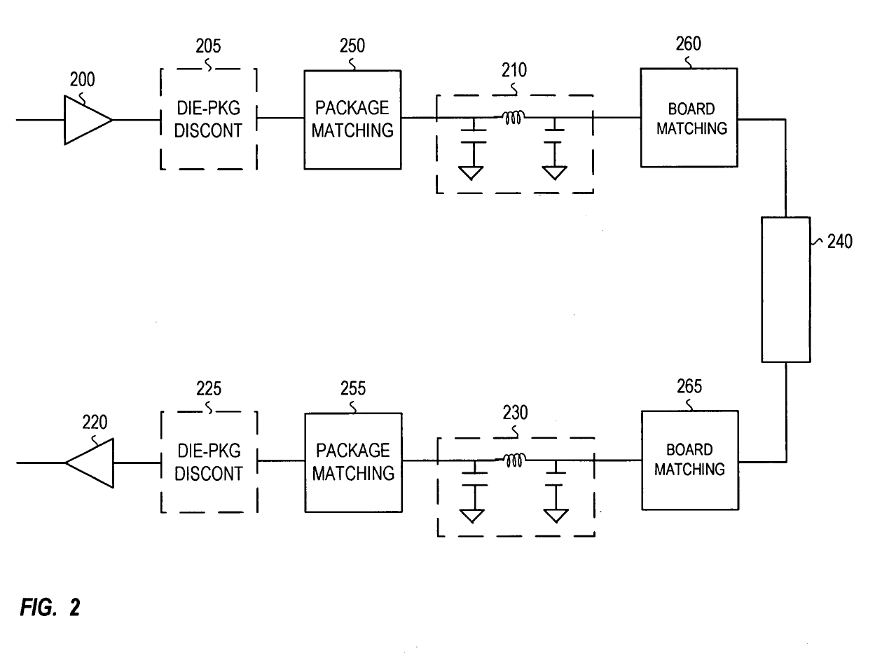

FIG. 2 illustrates an example schematic of impedance matching networks being utilized in a connection between a transmitter and receiver. A transmitter 200 may have die-package discontinuities 205 caused by at least some subset of the die-package connection, ESD—protection circuits on the die, and active circuits on the die. The die-package discontinuities 205 may be complex impedances that vary with varying frequencies. The transmitter 200 may also have package-board discontinuities 210 caused by the package board connection. The package-board discontinuities 210 are illustrated as including a combination of capacitors and inductors. A receiver 220 may also have die-package discontinuities 225 and package-board discontinuities 230. The transmitter 200 and the receiver 220 may be connected using a trace 240 on the board. A typical trace for a personal computer or server may be a 50-ohm trace. The traces may be drawn as a single wire or as a differential pair (coupled transmission line).

Impedance matching networks 250, 255 may be introduced near the die-package discontinuities 205, 225 respectively to adjust for the complex impedance created thereby. The impedance matching networks 250, 255 may be located within the transmitter and receiver packages respectively. Impedance matching networks 260, 265 may be introduced near the package-board discontinuities 210, 230 respectively to adjust for the complex impedance created thereby. The impedance matching networks 260, 265 may be located on the board near the transmitter and receiver connections respectively. The impedance matching networks 250, 255, 260, 265 may consist of stepped impedance transformers. The stepped impedance transformers may provide varying amounts of impedance for different frequencies to enable impedance matching between the transmitter and the receiver for different frequencies. The stepped impedance transformers are passive devices that may provide analog equalization of the impedance discontinuities in high speed serial links.

The stepped impedance transformers may be implemented within traces that already exist on the packages of the transmitter and receiver and on the board. By implementing the stepped impedance transformers in exiting traces no modifications to existing package/board design methodology or technology. By utilizing stepped impedance transformers on the package traces there is no need for high-Q inductors or other special requirements to be formed on the die (digital CMOS process) to account for impedance mismatches. The use of existing routing layers (traces) on packages already in use provides an economical solution

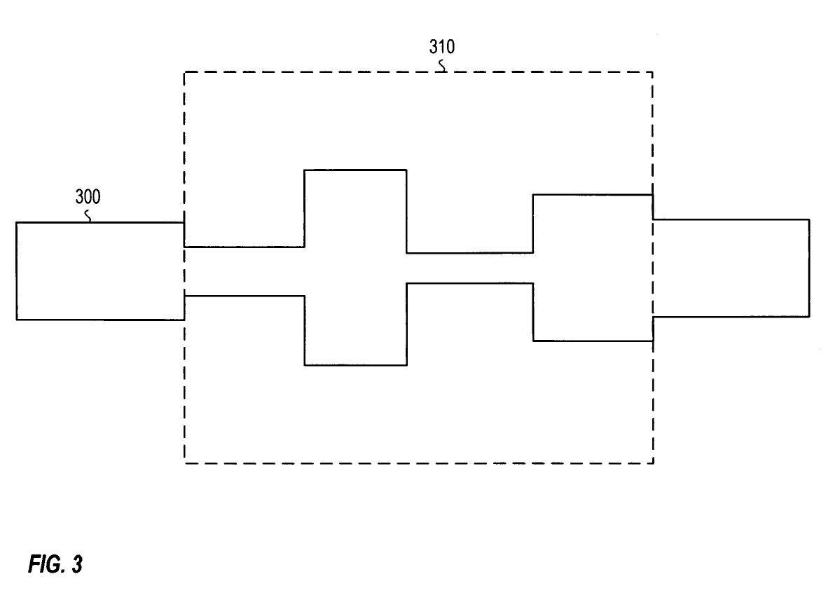

FIG. 3 illustrates an example trace 300 having a stepped impedance transformer 310 formed therein. The trace 300 may be a microstrip, a strip line or a coupled transmission line. A typical trace used in a personal computer or server may have a width that provides a 50 ohm impedance for a specific combination of dielectric constant, loss tangent, trace-thickness and height above the ground plane. The stepped impedance transformer 310 may include traces of varying widths, where the width dictates the impedance. A wider trace may equate to a lower impedance and a narrower trace may equate to a higher impedance. The more sections of varying width and thus varying values of impedance results in a finer granularity of impedance matching over varying frequencies. The different impedances provided in the stepped impedance transformer 310 can be determined empirically or analytically. In addition to the width, the length of individual segments in the matching network can be chosen to provide a desired frequency response.

Since the stepped impedance transformers 310 are modeled using empirically obtained parameters such as thickness, dielectric constant, loss tangent etc., there may be modeling inaccuracies. To account for these possible modeling inaccuracies active circuits on the die of the transmitter and/or receiver may be biased and sized to provide specific input/output impedances so that the stepped impedance transformers 310 can provide the appropriate matching.

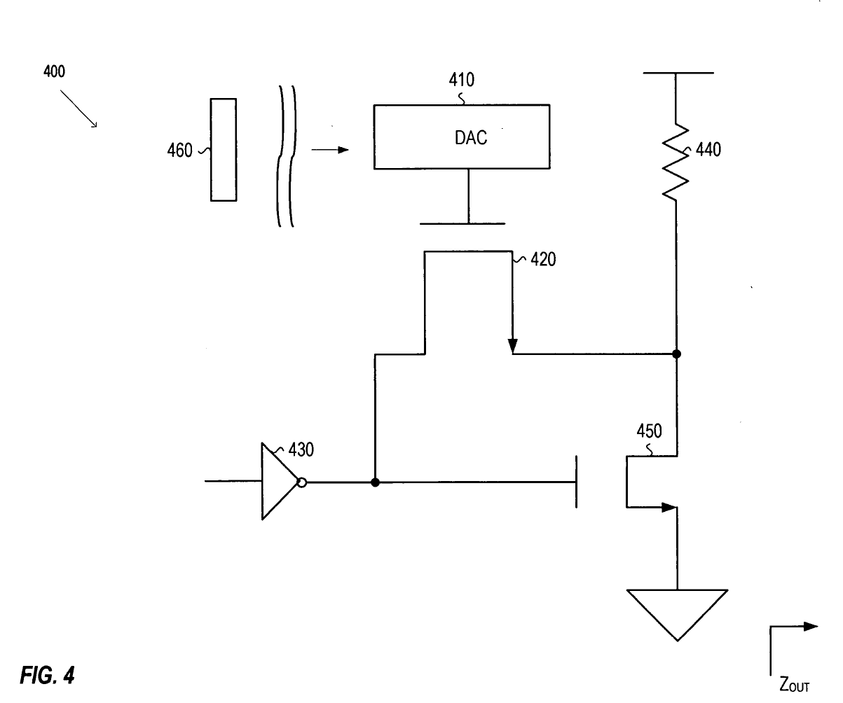

FIG. 4 illustrates an example output impedance selecting circuit 400 for a transmitter. The selecting circuitry 400 includes a digital to analog converter (DAC) 410, a transistor 420, a transmitter driver 430, a resistor 440, and a transistor 450. The DAC 410 receives biasing currents from control circuits on the die 460 and converts these biasing currents to an analog signal that is provided to a gate of the transistor 420. The transmitter output impedance is adjusted by changing bias currents through the DAC 410. The biasing currents can be used to calibrate any modeling errors in the impedance matching network(s) or correct for any variations in the impedance of the transmitter that may occur due to process, voltage, or temperature (PVT) changes. The die may also include a bit error measurement unit and a feedback loop to assist in the adjustment of the biasing currents (DAC settings).

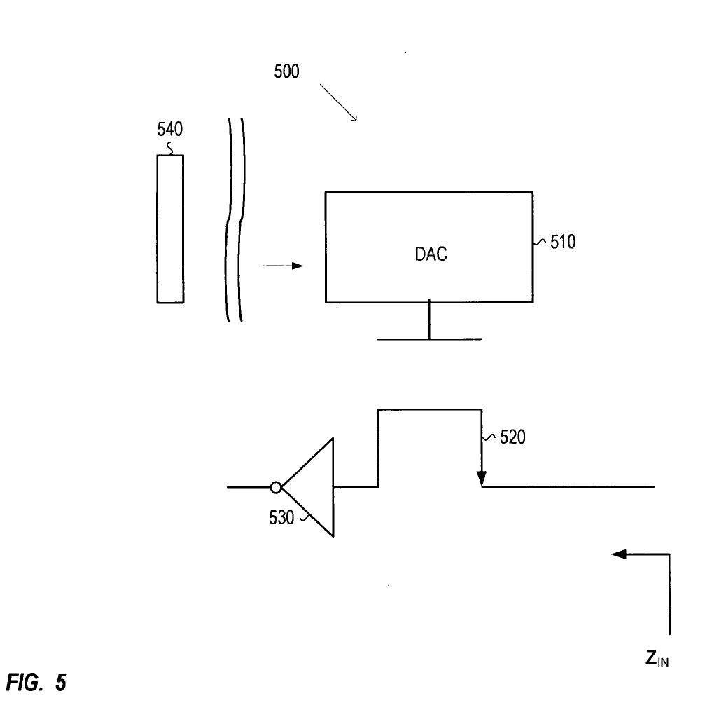

FIG. 5 illustrates an example input impedance selecting circuit 500 for a receiver. The selecting circuitry 500 includes a digital to analog converter (DAC) 510, a transistor 520, and a driver 530. The DAC 510 receives biasing currents from control circuits on the receiver die 540 and converts these biasing currents to an analog signal that is provided to a gate of the transistor 520. The transistor 520 is a wide-band common gate front end that is biased for an input impedance of 1/transconductance of the transistor (gm), with gm controlled by the DAC 510.

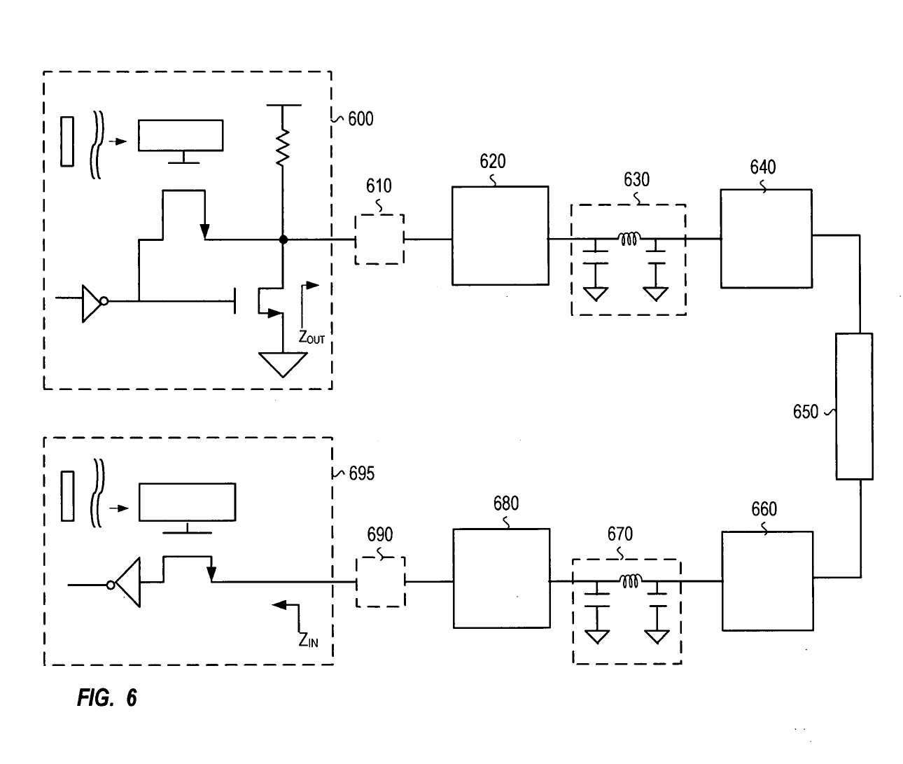

FIG. 6 illustrates an example schematic of passive impedance matching networks and active impedance selecting circuitry being utilized in high-speed serial links. A transmitter die includes an active output impedance selecting circuit 600 (e.g., 400) to provide digital control of the output impedance of the transmitter. Discontinuities 610 exist at the die package interface. A package impedance matching network (stepped impedance transformers (e.g., 310)) 620 is drawn in traces within the package. Discontinuities 630 exist at the package board interface. A board impedance matching network (stepped impedance transformers) 640 is drawn in traces within the board. A trace 650 in the board connects the transmitter to a receiver. A board impedance matching network (stepped impedance transformers) 660 is drawn in traces within the board to account for discontinuities 670 that exist at the package board interface of the receiver. A package impedance matching network (stepped impedance transformers) 680 is drawn in traces within the package to account for discontinuities 690 that exist at the die package interface of the receiver. The receiver die includes an active input impedance selecting circuit 695 (e.g., 500) to provide digital control of impedance input to the receiver.

The transmitter and receiver impedance biasing circuits (e.g., 400, 500) can be utilized to adjust the impedance bias of the transmitter and receiver respectively based on feedback from other components of the system (e.g., server, computer) to attempt to match impedances within the system and increase operation of the overall system. The adjustments to the impedance bias can be done with or without the existence of the impedance matching networks in the serial links.

FIGS. 1-6 have focused on discontinuities that may exist between integrated circuits on a circuit board (e.g., discontinuities at die/package and package/board connection points) and implementing the passive impedance matching networks in the traces within the packages or on the board. The passive impedance matching networks may be implemented on circuit boards used in any number of applications, including computers.

However, discontinuities and the resulting impedance mismatches are not limited to integrated circuits on circuit boards. Rather, the discontinuities can exist at any connection points between any devices. For example, discontinuities may exist at an interface connection between two circuit boards.

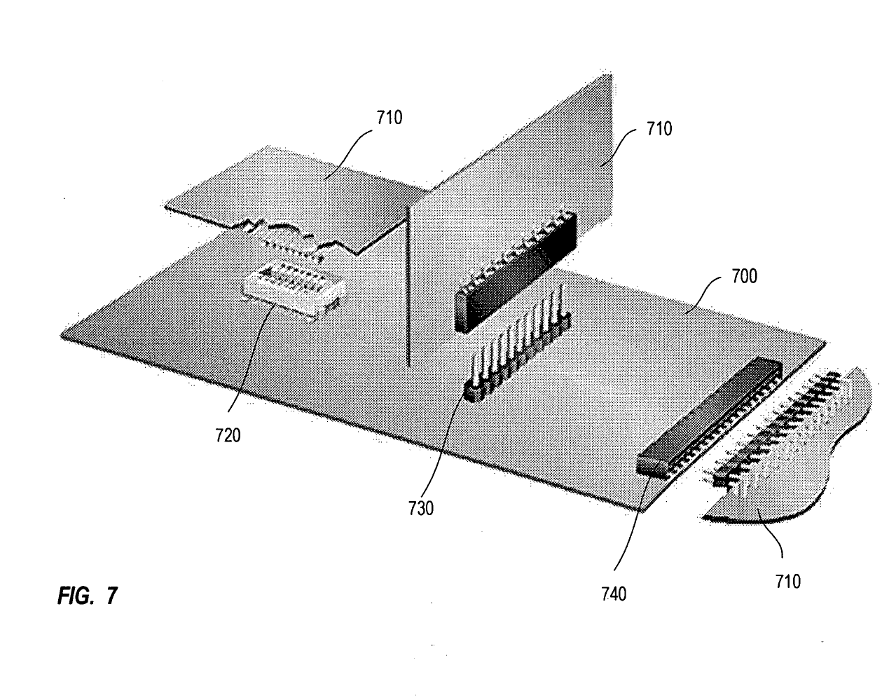

FIG. 7 illustrates several example connections between circuit boards. A backplane (motherboard) 700 may receive multiple other boards (e.g., daughter cards) 710. The other boards 710 may connect to the backplane via interface connectors. The interface connectors may include a male portion mounted to one of the boards and a female portion mounted to another board. The daughter cards 710 may mount to the backplane 700 as a mezzanine 720, where the daughter card 710 is mounted above at least a portion of the backplane 700. This embodiment entails the circuit boards having connectors mounted on their faces and the connectors on the faces of the boards being placed together. The daughter cards 710 may be mounted to the backplane 700 at a right angle 730. This embodiment entails the backplane 700 having a connector mounted on a face and the daughter card 710 having a connector mounted on an edge so that the edge of the daughter card 710 is abutted to the face of the backplane 700. The daughter card 710 may be mounted to the backplane 700 in a planar fashion (in the same plane) 740. This embodiment entails both the backplane 700 and the daughter card 710 having connectors mounted on edges and the edges connected together.

The connectors 720, 730, 740 may create impedance discontinuities between the circuit boards. Broadband matching networks (stepped impedance transformers) may be implemented on one or both sides of the interface connectors (on the backplane, the daughter card, or both). The stepped impedance transformers may be formed in the traces on the circuit board(s) connecting to the interface connector. The stepped impedance transformers may be formed in a package of an integrated circuit that is coupled to the interface connector.

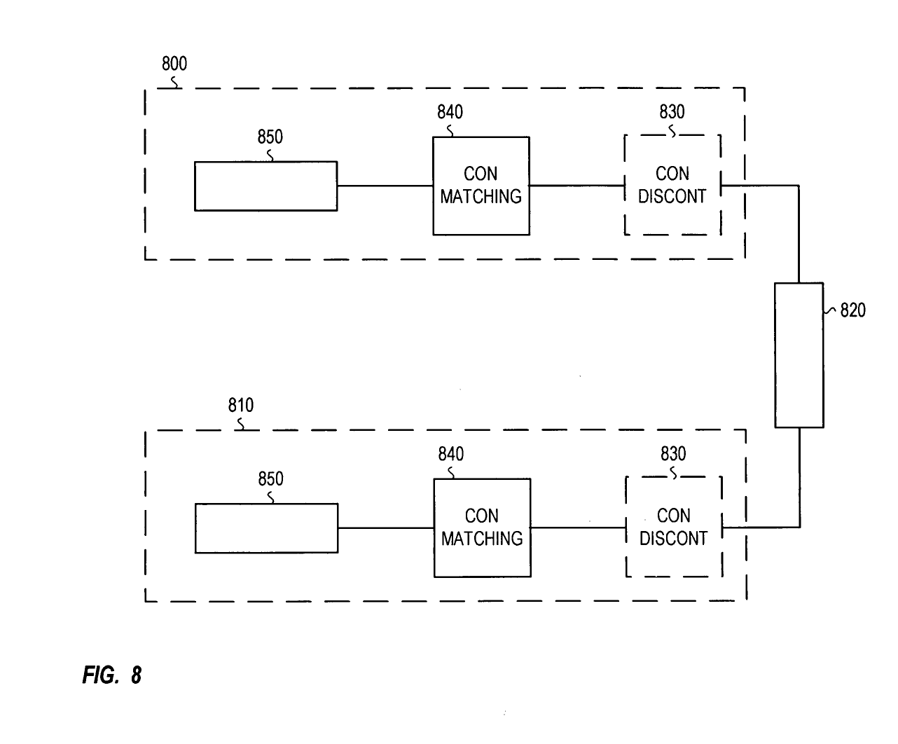

FIG. 8 illustrates an example schematic of impedance matching networks being utilized in a connection between circuit boards. A first circuit board (e.g., a backplane) 800 may be connected to a second circuit board (e.g., a daughter card) 810 using an interface connector 820. The connector 820 may have impedance discontinuities due to the non-ideal nature of the connectors. The impedance discontinuities are illustrated as connector discontinuities 830 on each circuit board. The first circuit board 800, the second circuit board 810 or both may include connector matching networks (stepped impedance transformers) 840 formed in the traces 850.

The passive impedance equalization scheme has the promise of relaxing the power-performance tradeoff in high speed serial links. The equalization of the impedance of the transmitter and receiver decrease the power reflections and increases the power transmission over varying frequencies. The increase in power received by the receiver increases the performance (quantified by the data-rate) of the serial link. Accordingly, performance may be maintained and power required may be reduced (save battery life) or the power can be maintained and the performance can be increased.

According to one embodiment, the passive impedance equalization scheme can be combined with active equalizers or on chip inductive terminations to improve system performance or reduce dissipated power.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. It may be possible to implement, for example, some or all components of various embodiments in software and/or firmware as well as hardware, as known in the art. Embodiments may be implemented in numerous types of hardware, software and firmware known in the art, for example, integrated circuits, including ASICs and other types known in the art, printed circuit broads, components, etc.

The various embodiments are intended to be protected broadly within the spirit and scope of the appended claims.

What is claimed:

1. A high-speed serial link between devices, the link comprising
at least one impedance discontinuity between devices; and
at least one passive impedance matching network located on a serial link between the devices.

2. The link of claim 1, wherein said at least one passive network includes at least one stepped impedance transformer.

3. The link of claim 2, wherein the devices are integrated circuits mounted on a circuit board.

4. The link of claim 3, wherein the at least one stepped impedance transformer is formed in a trace on a package of a first integrated circuit, wherein the trace connects a die of the first integrated circuit to the circuit board.

5. The link of claim 3, wherein the at least one stepped impedance transformer is formed in a trace on the circuit board, wherein the trace connects the integrated circuits.

6. The link of claim 3, wherein the at least one impedance discontinuity includes die-package discontinuities and package-board discontinuities.

7. The link of claim 3, further comprising active circuitry on the integrated circuits to control the output or input impedance of the integrated circuits.

8. The link of claim 2, wherein the at least one stepped impedance transformer is formed by drawing traces with varying sizes, wherein the traces connect the devices and the varying sizes create different impedances in the trace and help balance impedance imbalances between the devices over varying frequencies.

9. The link of claim 2, wherein the devices are circuit boards coupled together with an interface connector.

10. The link of claim 9, wherein the at least one stepped impedance transformer is formed on at least one of the circuit boards.

11. A device comprising
a circuit board;
at least two integrated circuits mounted on the circuit board;
a serial link between the at least two integrated circuits, wherein the serial link includes one or more package traces connecting integrated circuit die to the circuit board and one or more board traces connecting the at least two integrated circuits, and wherein the serial link may include impedance discontinuities; and
at least one stepped impedance transformer formed in the serial link

12. The device of claim 11, wherein the at least one stepped impedance transformer is formed in at least one package trace.

13. The device of claim 11, wherein the at least one stepped impedance transformer is formed in at least one board trace.

14. The device of claim 11, further comprising active circuitry on the integrated circuit die to bias impedance of the integrated circuits.

15. The device of claim 14, wherein the active circuitry includes a digital to analog converter to receive biasing currents from the die.

16. A device comprising
a first circuit board;
a second circuit board;
an interface connector to connect the first circuit board and the second circuit board; and
at least one stepped impedance transformer formed on at least some subset of the first circuit board and the second circuit board, wherein the at least one stepped impedance transformer alleviates impedance mismatches caused by non-ideal nature of the interface connector.

17. The device of claim 16, wherein the at least one stepped transformer is formed in board traces connecting to the interface connector.

18. The device of claim 16, wherein the at least one stepped transformer is formed in a package of an integrated circuit coupled to the interface connector.

19. A method comprising
implementing at least one stepped impedance transformer within a serial link between a transmitter and a receiver, wherein the at least one stepped impedance transformer acts as an impedance matching network.

20. The method of claim 19, wherein the at least one stepped impedance transformer is drawn in a package trace.

21. The method of claim 19, wherein the at least one stepped impedance transformer is drawn in a board trace.

22. A system comprising
a mother board;
a daughter card coupled at a right angle to the mother board using an interface connector; and
at least one stepped impedance transformer formed in traces leading to the interface connector on at least some subset of the mother board and the daughter card, wherein the at least one stepped impedance transformer alleviates impedance mismatches caused by non-ideal nature of the interface connector.

23. The system of claim 22, wherein one end of the interface connector is mounted to the mother board and another end of the interface connector is mounted to the daughter card.
